(19) United States
(12) Patent Application Publication
(10) Pub. No.: US 2009/0276546 A1
(43) Pub. Date: Nov. 5, 2009

(54) TECHNIQUES FOR DETECTION AND SERIAL COMMUNICATION FOR A NON-USB SERIAL INTERFACE OVER USB CONNECTOR

(75) Inventors: Ken Suen Kwong Lui, Fremont, CA (US); John Walley, Ladera Ranch, CA (US); George Andrew Wyper, Opio (FR); Nicholas Waylett, Santa Clara, CA (US); Long Wang, San Diego, CA (US); Craig Stein, Rancho Santa Margarita, CA (US); Ravindranath Singamneni, San Diego, CA (US)

Correspondence Address: BRAKE HUGHES BELLERMANN LLP;c/o CPA Global, P.O. Box 52050, Minneapolis, MN, 55402, US

(73) Assignee: Broadcom Corporation, Irvine, CA (US)

(21) Appl. No.: 12/197,030

(22) Filed: Aug. 22, 2008

Related U.S. Application Data
(60) Provisional application No. 61/049,684, filed on May 1, 2008.

(51) Int. Cl. G06F 3/00

(52) U.S. Cl. 710/16

(57) ABSTRACT

According to an example embodiment, an apparatus may include a non-Universal Serial Bus (non-USB) serial interface, a USB connector, a first protection circuit connected between a first data connection of the non-USB serial interface and a first data connection of the USB connector, a second protection circuit connected between a second data connection of the non-USB serial interface and a second data connection of the USB connector, a processor, and a detection circuit connected to the second data connection of the USB connector, the detection circuit configured to output a signal to the processor indicating an attachment or connection of a second non-USB serial interface to the USB connector.

### CROSS-REFERENCE TO RELATED APPLICATIONS

This application claims priority to U.S. Provisional application Ser. No. 61/049,684, filed on May 1, 2008, entitled “Techniques for Detection and Serial Communication For a Non-USB Serial Interface Over USB Connector,” hereby incorporated by reference.

### BACKGROUND

Universal Serial Bus (USB) is a serial bus standard to interface devices together. USB may include a number of different versions, such as USB 1.0, USB 2.0, USB 3.0, etc. USB may also include a number of different standard connectors or plugs, such as Standard A, Standard B, mini B, micro A, micro B, micro AB, etc. USB typically provides for several connections or pins, including a ground, two differential data lines (D+, D−), and a power line or VCC (or VBus). USB may allow data to be transferred between devices by using the two differential data lines or signals (D+, D−) to provide half duplex (bidirectional transmission, with only one side able to transmit at a time) data transmissions between devices. The USB power line may allow one device to supply power to another connected device (e.g., to charge a battery).

### SUMMARY

Various example embodiments are disclosed relating to techniques for detection and serial communication for a non-USB serial interface over a USB connector.

### BRIEF DESCRIPTION OF THE DRAWINGS

FIG. 1 is a block diagram of a system according to an example embodiment.

FIG. 2 is a flow chart illustrating operation of a device according to an example embodiment.

### DETAILED DESCRIPTION

In an example embodiment, two computing devices may be coupled together to allow for battery charging (power feed) and/or communication between the devices. For example, USB connectors or USB ports may be provided on both devices to allow charging (or power feed) to one of the devices and to allow data communication between the two devices. While USB may provide data communication, implementing the USB data communication standard may typically require use of a USB protocol stack, which may increase complexity and cost of a device. Other (e.g., simpler or less expensive) serial interfaces (non-USB serial interfaces) are available, such as a Universal Asynchronous Receiver Transmitter (UART) for serial data communications, which may be more appropriate or a better fit as compared to USB communications, at least for some applications or circumstances.

Therefore, according to an example embodiment, a device may include a USB port or connector to allow for power feed (battery charging). And, rather than providing USB serial communications over the USB connector, the remaining data and ground pins on the USB connector may be used to provide non-USB (e.g., UART or other non-USB serial interface) serial communications. As compared to providing USB serial communication over a USB connector or port (which is a conventional or traditional usage of a USB connector), providing a non-USB serial communication over a USB connector may provide a simpler and/or less expensive data communication while still using a standard USB connector. Further examples and details will be described with reference to the example embodiments provided herein.

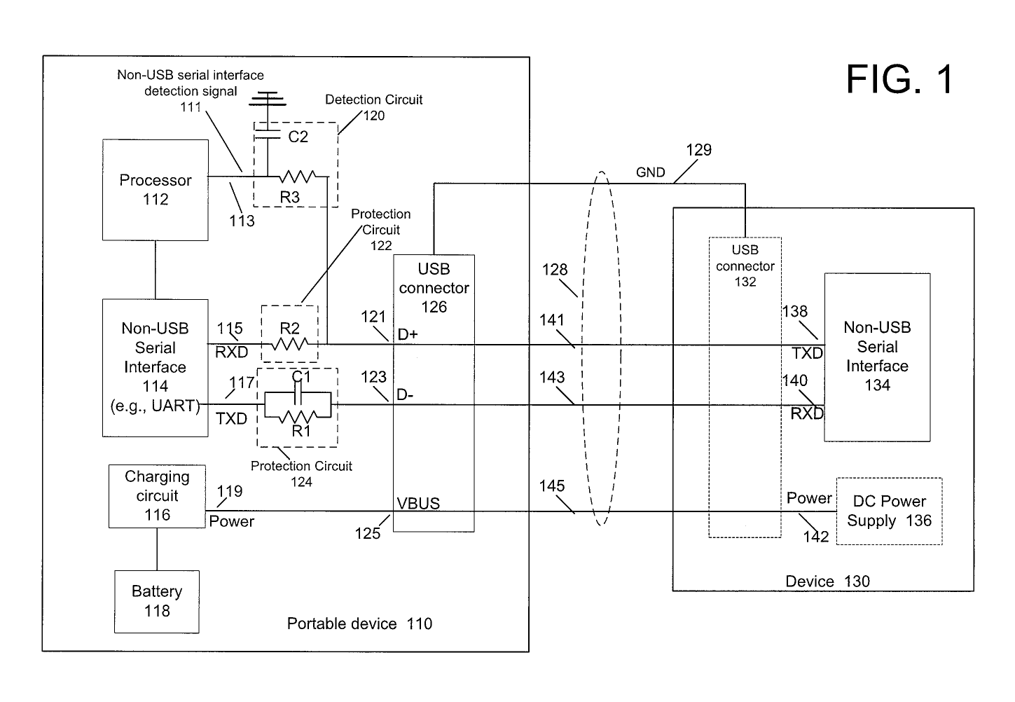

FIG. 1 is a block diagram of a system according to an example embodiment. A portable device 110 may be connected to a device 130 via a cable 128. Device 110 may be any type of computing device. Device 110 may, for example, be a portable device, such as a cell phone, wireless headset, PDA (personal digital assistant), or other wireless or mobile device, as examples. Device 130 may also be any type of computing device, such as, for example, a PC (personal computer), laptop, or other device.

Device 110 may include a processor 112 for providing overall control for device 110 and executing instructions or code, a non-USB serial interface 114 to perform serial communications, a battery 118 to provide power to device 110, and a charging circuit 116 to charge battery 118, e.g., based on a received power signal received via power line 1 19. Non-USB serial interface 114 may be any type of non-USB serial interface, and in an example embodiment, may be a Universal Asynchronous Receiver Transmitter (UART). A UART is merely one example of a non-USB serial interface, and other non-USB serial interfaces may be used. Although not shown, device 110 may include memory, one or more input/output devices (e.g., keyboard, mouse, display, pointing device and the like). Device 110 may also include a USB connector 126, which may include a number of connections or pins, such as a ground connection, data connections 121 (D+) and 123 (D−), and a power connection 125 (VBUS or VCC) for power supply or power feed. USB connector 126 may be any type of USB connector.

Device 130 may similarly include a non-USB serial interface 134, which may be any type of non-USB serial interface, such as, for example, a UART interface. UART is merely an example non-USB serial interface, and other non-USB serial interfaces may be used. A DC power supply 136 may provide power to device 130, and may also supply or feed power to device 110 when connected to device 110, e.g., via power line 145 of cable 129. Although not shown, device 130 may include a processor, memory, input/output devices (e.g., keyboard, mouse, display, pointing device and the like). Non-USB serial interface 134 may include a transmit data connection (TXD) 138, a receive data connection (RXD) 140, and other connections. A power connection 142 may be coupled to DC power supply 136. In an example embodiment, device 130 may include a USB connector 132 connected to non-USB serial interface 134. USB connector 132 may be any type of USB connector.

A cable 128 may be connected to USB connector 132. Cable 128 may be any type of cable or media, and may, for example, include one or more communications lines or links or conductors for communicating signals, data, power, etc. Cable 128 may, for example, include a ground line 129 for providing a ground signal or ground voltage, data lines 141 and 143, and a power line 145, as examples. Data connections 138 (TXD) and 140 (RXD) of non-USB serial interface 134 and power connection 142 may be connected to data lines 141 and 143, and power line 145, respectively, of cable 128.

In an example embodiment, a cable 128 may be coupled to one or both of USB connectors 126 and 132. For example, when device 130 is attached or connected to device 110, cable 128 may be connected to both USB connectors 126 and 132, thereby coupling devices 130 and 110 (e.g., coupling non-USB serial interfaces 114 and 134). For example, when device 130 is connected to device 110, data connections 121 and 123 and power connection 125 of USB connector 126 may be connected to data lines 141 and 143, and power line 145, respectively, of cable 128.

In an example embodiment, when devices 110 and 130 are connected via cable 128, non-USB serial interface 114, when enabled, may transmit data to non-USB serial interface 134 via a path that may include, for example, transmit data connection (TXD) 117 of non-USB serial interface 114, data connection 123 of USB connector 126, and data line 143 of cable 128, to receive data connection (RXD) 140 of non-USB serial interface 134. Likewise, non-USB serial interface 134, when enabled, may transmit data to non-USB serial interface 114 via a path that may include transmit data connection (TXD) 138 of non-USB serial interface 134 to USB connector 132, and data line 141 of cable 128, to data connection 121 of USB connector 126, and to receive data connection (RXD) 115 of non-USB serial interface 114.

In an example embodiment, non-USB serial interface 114 may initially be in an idle state (no data being transmitted). For example, when a UART (or other valid non-USB serial interface) is in an idle state (not transmitting data), the UART may provide or output a logic high or a high voltage (e.g., 5 volts) on the transmit data connection (TXD). In other words, the serial output from the UART may typically idle at the logic high (mark) level. In contrast, a USB device (or USB serial interface), when in idle state or not transmitting, does not output a logic high on a transmit data line. This difference in behaviour between a USB serial interface and a valid non-USB serial interface (e.g., UART serial interface) may distinguish between the attachment of USB serial interface vs. valid non-USB serial interface, e.g., allow for portable device 110 and/or device 130 to determine or detect when a valid non-USB serial interface is connected or attached (and may also confirm that a USB serial interface is not connected or attached), according to an example embodiment.

According to an example embodiment, there may be one or more attachment modes for non-USB serial interface 114 (or for device 110). The attachment modes for device 110 may include:
1) No attachment or connection to device 110, meaning that another device is not attached to the USB connector 126 of device 110. 2) Power supply attachment only, meaning that a device is attached (e.g., via a cable) to USB connector 126, but is only providing power feed to charging circuit 116, e.g., via line 145 and power connections 125 and 119. In this case, no data is being transmitted to or from device 110, for example. 3) Attachment of a USB device (not shown in FIG. 1) to USB connector 126 via a cable 128. And, 4) attachment of a valid (or target) non-USB serial interface (e.g., device 134) to device 110 (coupled to non-USB serial interface 114 via attachment to USB connector 126).

According to an example embodiment, attachment of a USB device to device 110 may allow a potentially damaging situation to arise where two different devices (e.g., a UART or non-USB serial interface 114 and a USB device) may attempt to communicate or drive the same data lines at the same time, causing a signal conflict or potentially damaging currents or voltages at one or both of the devices. For example, there exists the possibility that someone may plug in (or connect or attach) a USB device into USB connector 126, since USB connector 126 may be a standard USB connector. However, interface 114 may be, for example, a non-USB serial interface, such as a UART, which may have different or conflicting protocols, signals, voltages, etc., as compared to a USB device. Thus, it may be desirable, for example, for device 110 (and possibly device 130) to first detect the connection or attachment to device 110 of a valid (or target) non-USB serial interface (e.g., interface 134) before enabling non-USB serial interface 114 to transmit data to device 130.

The attachment mode 4) (attachment of a valid or target non-USB serial interface 134) may allow, for example, devices 110 and 130 to safely communicate via UART (or non-USB) communications, but provided through a standard USB connector(s). For example, this may allow for a host computer (e.g., device 130) to download firmware, configuration update to device 110, issue commands or testing data, memory peek and poke commands or instructions (e.g., to read from or write to memory of device 110), to monitor tests or obtain test results of device 110 during testing, assembly, etc., acquire data, test results or other information from device 110, or other purpose. For example, during test of a device (e.g., wireless or Bluetooth headset), firmware and test data may be downloaded from a UART on a host PC 130 to device 110 via UART 114, and test results sent back to device 130, e.g., to allow host PC to configure or test device 110 prior to sale or distribution. This is just an example and the embodiments are not limited thereto. Non-USB serial interface 114 may initially be in disabled mode, that is, the non-USB serial interface has not been permitted or enabled to transmit data yet. If a valid non-USB serial interface or device (e.g., interface 134) has been detected by device 110 as being attached to device 110, then the non-USB serial interface 114 may be enabled to allow interface 114 to transmit data to device 130. Similarly, device 130 may detect a valid non-USB serial interface connected to device 130 before transmitting data. The communication between devices 110 and 130 may be performed, e.g., for testing and/or configuration of device 110, downloading firmware to device 110, receiving test results or other information from device 110, and/or for other purposes. Once testing or configuration of device 110 is completed, for example, the non-USB serial interface (e.g., UART) 114 may be disabled (e.g., either automatically based on detection of non-attachment or disconnecting of non-USB serial interface 134 or device 130), or manually based on a button press or other technique).

In an example embodiment, device 110 may include a protection circuit 124 connected to transmit data connection 117 and data connection 123, to protect device 110 and/or device 130 from potentially damaging or harmful voltages and/or currents. Potentially damaging current or voltages may occur or result when, e.g., a conflicting or incompatible serial interface may be connected to device 110 (such as a USB or other incompatible serial interface is connected to non-USB serial interface 114). For example, protection circuit 124 may include a protection resistor R1 and a capacitor C1, provided in parallel.

For example, protection resistor R1 may decrease the current flowing over data line 143 between interfaces 114 and 134, and/or decrease a potentially damaging or conflicting DC voltage between devices 110 and 130. Capacitor C1 may be a signal bypass capacitor which may block potentially damaging DC voltages or signals, while allowing data signals (e.g., High-Low and/or Low-High signal transitions) to pass. The signal bypass capacitor C1 may be used on the transmit side (TXD) to decrease the signal attenuation that may occur via protection resistor. The data signal may sometimes, for example, be attenuated by or within cable 128, and at other points. Thus, because this signal attenuation is usually unknown by the transmitting device, signal bypass capacitor my decrease the amount of signal attenuation for signals received by the other device (device 130 in this example).

Similarly, a second protection circuit 122 may be connected between data connection 115 and data connection 121, and may include, for example, a resistor R2, to attenuate or decrease a potentially damaging current or voltage that may occur between devices 110 and 130 (e.g., between interfaces 114 and 134).

In an example embodiment, a detection circuit 120 may be connected to processor 112 and data connection 121 of USB connector 126. Detection circuit 120 may output a signal (e.g., a non-USB serial interface detection signal 111) on line 113 to processor 112 indicating whether or not a (e.g., valid) non-USB serial interface is connected or attached to the USB connector 126 of device 110. For example, the detection circuit 120 may include a protection resistor R3 and a shunt capacitor C2. R3 and C3 may form an RC circuit (resistor capacitor circuit), and may be or operate as, a low pass filter, e.g., to pass the DC or low frequency signals, while filtering the higher frequency signals (such as data signals).

In an example embodiment, the resistor R3 of detection circuit 120 may be coupled to ground via capacitor C2, e.g., R3 may be pulled down via capacitor C2. Thus, in the absence of a high signal (e.g., 5 volts), processor 112 will receive a low signal on line 113, due to internal pull-down resistor of 114 through R3 and R2. As noted above, when a UART (as an example) is in idle (or non-transmitting mode), the UART will transmit or drive a high on its transmit data connection (TXD 138, from device 130. This high signal, from device 130 or UART 134 of device 130, may be applied to data connection 121, and then input to detection circuit 120. Detection circuit 120 may remove any data signals, while passing the DC voltage to processor 112. A logic low, or a low DC voltage (e.g., approximately 0 volts) may indicate that a valid non-USB serial interface is not attached to USB connector 126 of device 110. In such case, detection circuit 120 will provide a low to processor 112, e.g., a low on the non-USB serial interface detection signal 111 (a low on signal 111, indicating that a valid non-USB serial interface is not connected to USB connector 126. Similarly, when a second UART 134 (e.g., an example of a valid non-USB serial interface) is connected or attached to USB connector 126 or to device 110, the high output by UART 134 while in idle state is received by detection circuit 120, and detection circuit outputs a high on the non-USB serial interface detection signal 111 (e.g., indicating that a valid non-USB serial interface is attached or connected to the USB connector 126/device 110). A subsequent data transmission, which may involve a temporary transition from High to Low, may not necessarily be detected by processor 112 of device 110, due to capacitor C2 removing or filtering higher frequency signals.

After processor 112 detects a logic high or a high (e.g., 5V or other high value) on line 113 (which, for example, may indicate an attachment or connection of a valid non-USB serial interface), processor 112 may enable non-USB serial interface 114 to transmit data to device 130. Device 130 may similarly be determining whether a valid non-USB serial interface is attached to USB connector 132, e.g., based on a voltage or DC signal value on the RCD connection 140.

After devices 110 and 130 are enabled to transmit data (e.g., based on a high received via a non-USB serial interface detection signal 111), the two devices 110, 130 may exchange data. Also, for example, after data has been exchanged, device 130 may be disconnected or unattached to device 110 (USB connector 120). When device 130 is no longer attached to device 110, then the signal input to processor 112 will go back to low voltage (due to pull down of internal pull-down resistor (not shown and provided within interface 114) at 115 through R3 and R2). Thus, processor 112 of device 110 may determine when another valid non-USB serial interface has been attached or connected to device 110, and when the device 130 may be disconnected (or no longer attached) to device 110/USB connector 120.

In an example embodiment, an apparatus may include a non-Universal Serial Bus (non-USB) serial interface, a USB connector, a first protection circuit connected between a first data connection of the non-USB serial interface and a first data connection of the USB connector, a second protection circuit connected between a second data connection of the non-USB serial interface and a second data connection of the USB connector, a processor, and a detection circuit connected to the second data connection of the USB connector, the detection circuit configured to output a signal to the processor indicating an attachment or connection of a second non-USB serial interface to the USB connector.

In an example embodiment, the detection circuit may include a resistor capacitor (RC) filter coupled to the second data connection of the USB connector, the RC filter being configured to output a non-USB serial interface detection signal to the processor indicating whether a valid non-USB serial interface is connected to the USB connector.

In an example embodiment, the non-Universal Serial Bus (non-USB) serial interface comprises a Universal Asynchronous Receiver Transmitter (UART).

In another example embodiment, an apparatus for providing non-Universal Serial Bus (non-USB) serial communications via a USB connector is provided. The apparatus may include a non-USB serial interface, a first capacitor and a first resistor coupled in parallel, the first capacitor and the first resistor being coupled between a first data connection of the non-USB serial interface and a first data connection of the USB connector, a second resistor coupled between a second data connection of the non-USB serial interface and a second data connection of the USB connector, and a resistor capacitor (RC) filter coupled to the second data connection of the USB connector, the RC filter being configured to output a non-USB serial interface detection signal indicating whether a valid non-USB serial interface is connected to the USB connector.

In an example embodiment, the non-USB serial interface may include a Universal Asynchronous Receiver Transmitter (UART). In another example embodiment, the first capacitor may include a signal bypass capacitor to allow signals transmitted from the non-USB serial interface to be transmitted.

In an example embodiment, the RC filter may include a third resistor having a first end coupled to both the second resistor and the second data connection of the USB connector, and a second end coupled to a second capacitor, the second capacitor also coupled to ground. In an example embodiment, the RC filter may include a third resistor and a second capacitor, the third resistor having a first end coupled to both the second resistor and the second data connection of the USB connector, the third resistor also including a second end coupled to the second capacitor, the second capacitor also coupled to ground.

In an example embodiment, the apparatus may further include a processor configured to detect a presence of a valid non-USB serial interface being connected or attached to the USB connector based on a voltage output by the RC filter.

In an example embodiment, the apparatus may further include a charging circuit configured to receive a power signal via the USB connector for battery charging.

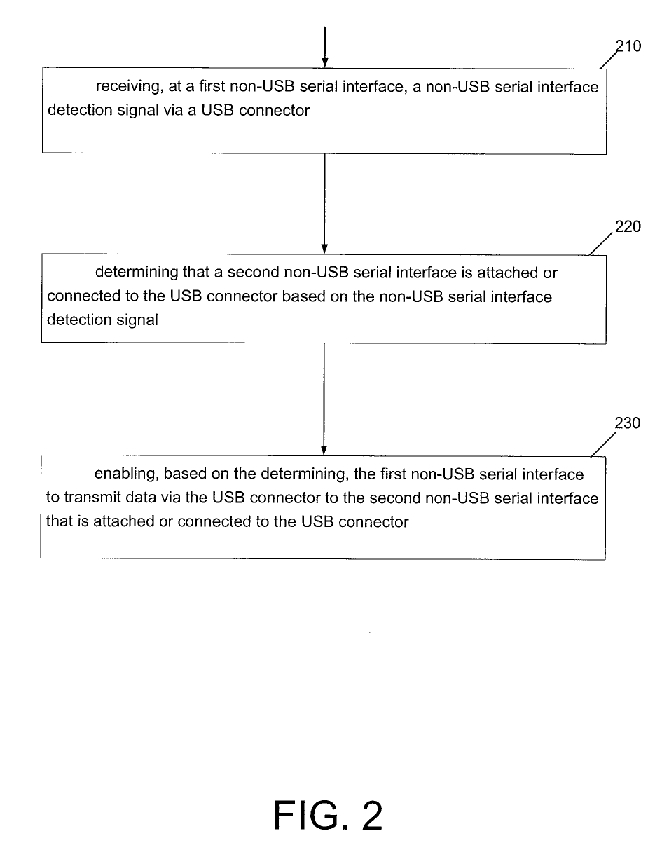

FIG. 2 is a flow chart illustrating operation of a device according to an example embodiment. A method may be provided of providing non-Universal Serial Bus (non-USB) serial communications via a USB connector. The method may include (210) receiving, at a first non-USB serial interface, a non-USB serial interface detection signal via a USB connector, (220) determining that a second non-USB serial interface is attached or connected to the USB connector based on the non-USB serial interface detection signal, and (230) enabling, based on the determining, the first non-USB serial interface to transmit data via the USB connector to the second non-USB serial interface that is attached or connected to the USB connector. The method may further include transmitting serial data from the first non-USB serial interface via the USB connector to the second non-USB serial interface that is attached or connected to the USB connector.

The method may further include receiving an input from a user, wherein the enabling comprises enabling of the first non-USB serial interface to transmit data via the USB connector to the second non-USB serial interface based on the determining and the receiving the input from a user. The method may further include receiving an input from a user via a button or other user interface, wherein the enabling comprises enabling of the non-USB serial interface to transmit data via the USB connector to the valid non-USB serial interface based on the determining and the receiving the input from a user.

The method may further include receiving a power signal via the USB connector for battery charging. The method may further include determining that a non-USB serial interface is unattached or disconnected to the USB connector based on the non-USB serial interface detection signal, and disabling the first the first non-USB serial interface to transmit data via the USB connector based on the determining that a non-USB serial interface is unattached or disconnected to the USB connector.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

What is claimed is:

1. An apparatus comprising:
a non-Universal Serial Bus (non-USB) serial interface;
a USB connector;
a first protection circuit connected between a first data connection of the non-USB serial interface and a first data connection of the USB connector;
a second protection circuit connected between a second data connection of the non-USB serial interface and a second data connection of the USB connector;
a processor; and
a detection circuit connected to the second data connection of the USB connector, the detection circuit configured to output a signal to the processor indicating an attachment or connection of a second non-USB serial interface to the USB connector.

2. The apparatus of claim 1 wherein the detection circuit comprises a resistor capacitor (RC) filter coupled to the second data connection of the USB connector, the RC filter being configured to output a non-USB serial interface detection signal to the processor indicating whether a valid non-USB serial interface is connected to the USB connector.

3. The apparatus of claim 1 wherein the non-Universal Serial Bus (non-USB) serial interface comprises a Universal Asynchronous Receiver Transmitter (UART).

4. An apparatus for providing non-Universal Serial Bus (non-USB) serial communications via a USB connector, the apparatus comprising:
a non-USB serial interface;
a first capacitor and a first resistor coupled in parallel, the first capacitor and the first resistor being coupled between a first data connection of the non-USB serial interface and a first data connection of the USB connector;
a second resistor coupled between a second data connection of the non-USB serial interface and a second data connection of the USB connector; and
a resistor capacitor (RC) filter coupled to the second data connection of the USB connector, the RC filter being configured to output a non-USB serial interface detection signal indicating whether a valid non-USB serial interface is connected to the USB connector.

5. The apparatus of claim 4 wherein the non-USB serial interface comprises a Universal Asynchronous Receiver Transmitter (UART).

6. The apparatus of claim 1 wherein the first capacitor comprises a signal bypass capacitor to allow signals transmitted from the non-USB serial interface to be transmitted.

7. The apparatus of claim 4 wherein the RC filter comprises:
a third resistor having a first end coupled to both the second resistor and the second data connection of the USB connector, and a second end coupled to a second capacitor, the second capacitor also coupled to ground.

8. The apparatus of claim 4 and further comprising a processor, wherein the wherein the RC filter comprises:
a third resistor and a second capacitor, the third resistor having a first end coupled to both the second resistor and the second data connection of the USB connector, the third resistor also including a second end coupled to the second capacitor, the second capacitor also coupled to ground.

9. The apparatus of claim 4 and further comprising a processor configured to detect a presence of a valid non-USB serial interface being connected or attached to the USB connector based on a voltage output by the RC filter.

10. The apparatus of claim 4 and further comprising a charging circuit configured to receive a power signal via the USB connector for battery charging.

11. A method of providing non-Universal Serial Bus (non-USB) serial communications via a USB connector, the method comprising:
receiving, at a first non-USB serial interface, a non-USB serial interface detection signal via a USB connector;
determining that a second non-USB serial interface is attached or connected to the USB connector based on the non-USB serial interface detection signal;
enabling, based on the determining, the first non-USB serial interface to transmit data via the USB connector to the second non-USB serial interface that is attached or connected to the USB connector.

12. The method of claim 11 and further comprising transmitting serial data from the first non-USB serial interface via the USB connector to the second non-USB serial interface that is attached or connected to the USB connector.

13. The method of claim 11 and further comprising receiving an input from a user, wherein the enabling comprises enabling of the first non-USB serial interface to transmit data via the USB connector to the second non-USB serial interface based on the determining and the receiving the input from a user.

14. The method of claim 11 and further comprising receiving an input from a user via a button or other user interface, wherein the enabling comprises enabling of the non-USB serial interface to transmit data via the USB connector to the valid non-USB serial interface based on the determining and the receiving the input from a user.

15. The method of claim 11 and further comprising receiving a power signal via the USB connector for battery charging.

16. The method of claim 11 and further comprising:
determining that a non-USB serial interface is unattached or disconnected to the USB connector based on the non-USB serial interface detection signal; and
disabling the first the first non-USB serial interface to transmit data via the USB connector based on the determining that a non-USB serial interface is unattached or disconnected to the USB connector.
